(19) United States
(12) Patent Application Publication
(10) Pub. No.: US 2010/0048700 A1
(43) Pub. Date: Feb. 25, 2010

(54) LIQUID FORMULATION OF PYRETHROIDS

(75) Inventors: Lorna Elizabeth Davies, Kansas City, KS (US); Peter Baur, Schondorf (DE); Wolfgang Thielert, Odenthal (DE); Richard Dickmann, Dusseldorf (DE); Jurgen Kuhnhold, Bergisch Gladbach (DE); Heike Hungenberg, Langenfeld (DE)

Correspondence Address: STERNE, KESSLER, GOLDSTEIN & FOX P.L.L.C., 1100 NEW YORK AVENUE, N.W., WASHINGTON, DC, 20005, US

(73) Assignee: Bayer CropScience AG, Monheim (DE)

(21) Appl. No.: 12/307,844

(22) PCT Filed: Jun. 27, 2007
(86) PCT No.: PCT/EP07/05669

§ 371 Date: Nov. 5, 2009

(30) Foreign Application Priority Data
Jul. 8, 2006 (EP) 06014209.8

(51) Int. Cl. A01N 53/06; A01N 37/34

(52) U.S. Cl. 514/521; 514/520

(57) ABSTRACT

New agrochemical formulations have been found, comprising
at least one active agrochemical compound from the group of the pyrethroids
at least one surfactant
at least one solvent
a polar co-solvent,
which exhibit improved rain resistance and improved biological activity over known pyrethroid formulations.

Agrochemical formulations of pyrethroids in the form of emulsifiable concentrates (EC formulations) have already been disclosed. WO 1996/001047, for example, describes EC formulations which, in contrast to the compositions of the invention, comprise esters, vegetable oils or vegetable oil esters as solvents. US 2004-0063583 A1 discloses pyrethroid EC formulations, but discloses neither ethylhexyl lactate nor butyrolactone as ingredients. Likewise known are aqueous microemulsions of pyrethroids, from EP 0 257 286 and EP 0 500 401. Both publications, however, do not disclose the use of co-solvents, more particularly not of gamma-butyrolactone or ethylhexyl lactate. Other formulations of certain pyrethroids are known as well, from WO 01/70024, for example, but are aqueous formulations, whereas the formulations of the invention are non-aqueous.

These formulations that have already been described do not always possess the desired biological activity and rain resistance.

New agrochemical formulations have now been found, comprising
at least one active agrochemical compound from the group of the pyrethroids,
at least one surfactant,
at least one water-immiscible solvent,
at least one polar co-solvent.

As compared with the EC formulations of pyrethroids that have been described in the prior art, the formulations of the invention feature a high fraction of particular surfactants, and at least one polar co-solvent. This not only allows an emulsion to form after the formulations have been diluted in water, but also results in improved rain resistance and improved biological activity.

It has further been found that the formulations of the invention can be produced by mixing the stated ingredients until a homogeneous solution is obtained.

In one preferred embodiment the active agrochemical compound the formulations of the invention comprise is at least one active compound selected from acrinathrin, alpha-cypermethrin, beta-cyfluthrin, gamma-cyhalothrin, cypermethrin, deltamethrin, esfenvalerate, ethofenprox, fenpropathrin, fenvalerate, flucythrinate, lambda-cyhalothrin, permethrin, tau-fluvalinate, tralomethrin, zeta-cypermethrin, cyfluthrin, bifenthrin, cycloprothrin, eflusilanat, fubfenprox, pyrethrin, resmethrin and tefluthrin.

In one particularly preferred embodiment the active agrochemical compound the formulations of the invention comprise is beta-cyfluthrin and/or deltamethrin.

Surfactants suitable in accordance with the invention are alkanol alkoxylates of the formula

R—O—(—AO)ₘR′ (I)

in which
R stands for straight-chain or branched alkyl having 4 to 20 carbon atoms,
R′ stands for H, methyl, ethyl, n-propyl, isopropyl, n-butyl, isobutyl, tert-butyl, n-pentyl or n-hexyl,
AO stands for an ethylene oxide radical, a propylene oxide radical, a butylene oxide radical or for mixtures of ethylene oxide and propylene oxide radicals or butylene oxide radicals and
m stands for numbers from 2 to 30.

A preferred group of surfactants are alkanol alkoxylates of the formula

R—O—(—EO—)ₙ—R′ (I-a)

in which
R is as defined above,
R′ is as defined above,
EO stands for CH₂—CH₂—O— and
n stands for numbers from 2 to 20.

A particularly preferred group of surfactants are alkanol alkoxylates of the formula (I-a), in which n stands for numbers from 6 to 17.

An especially preferred group of surfactants are isotridecanol alkoxylates of the formula (I-a-1)

C₁₃H₂₇—O—(—CH₂—CH₂—O—)ᵤ—H (I-a-1)

in which
u stands for the average value 8.4, or of the formula (I-a-2)

C₁₃H₂₇—O—(—CH₂—CH₂—O—)ᵤ—H (I-a-2)

in which
u stands for the average value 15.

In one preferred embodiment the water-immiscible solvent the formulations of the invention comprise is an aromatic organic solvent or a mixture of aromatic organic solvents. Such solvents are available commercially, for example, under the name Solvesso®.

In another preferred embodiment the water-immiscible solvent the formulations of the invention comprise is an aromatic organic solvent and the polar co-solvent they comprise is at least one selected from dimethyl sulphoxide, N-alkylpyrrolidone (e.g. N-methylpyrrolidone, N-octylpyrrolidone), gamma-butyrolactone, ethylhexyl palmitate, 2-ethylhexyl S-lactate (also referred to below in simplified form as ethylhexyl lactate or EHL), cyclohexanone and dimethylpropyleneurea.

In another preferred embodiment the water-immiscible solvent the formulations of the invention comprise is a mixture of aromatic organic solvents and the polar co-solvent they comprise is at least one selected from dimethyl sulphoxide, N-alkylpyrrolidone (e.g. N-methylpyrrolidone, N-octylpyrrolidone), gamma-butyrolactone, ethylhexyl palmitate, ethylhexyl lactate, cyclohexanone and dimethylpropyleneurea.

A particularly preferred polar co-solvent is ethylhexyl lactate.

Another particularly preferred polar co-solvent is gamma-butyrolactone.

The substances of the invention preferably further comprise at least one anionic emulsifier. Use may be made of all substances which typically can be employed in agrochemical compositions. Preference is given to alkali metal salts and alkaline earth metal salts of alkyl-sulphonic acids or alkylarylsulphonic acids. Particular preference is given to alkaline earth metal salts of alkylarylsulphonic acids.

The formulations of the invention optionally comprise further additives from the groups of foam inhibitors, antioxidants and/or colorants.

The formulations of the invention preferably comprise a foam inhibitor. Suitable foam inhibitors include all substances which typically can be employed for this purpose in agrochemical compositions. Preference is given to silicone fluids and magnesium stearate. If present, the amount of foam inhibitor is usually 0.0001% to 0.1% by weight.

Suitable antioxidants include all substances which typically can be employed for this purpose in agrochemical compositions. Preference is given to butylated hydroxytoluene (2,6-di-tert-butyl-4-methylphenol, BHT).

Suitable colorants include all substances which typically can be employed for this purpose in agrochemical compositions. Mention may be made, by way of example, of titanium dioxide, pigmentary carbon black, zinc oxide and blue pigments, and also Permanent Red FGR.

The amount of active compound in the formulations of the invention is generally 0.5% to 15% by weight, preferably 1% to 10% by weight, more preferably 2% to 6% by weight.

The amount of surfactant in the formulations of the invention is generally 10% to 50% by weight and preferably 20% to 30% by weight.

The amount of anionic emulsifier in the formulations of the invention is generally 0% to 15% by weight, preferably 1% to 12% by weight, more preferably 1% to 10% by weight.

The amount of solvents in the formulations of the invention is generally 30% to 90% by weight, preferably 40% to 80% by weight and more preferably 40% to 70% by weight. This figure stands for the total amount of aromatic organic solvents and any polar co-solvent present.

Particular attention is drawn to formulations of the invention comprising
2% to 6% by weight of deltamethrin and/or beta-cyfluthrin
20% to 30% by weight of surfactant from the group of the alcohol ethoxylates
40% to 70% by weight of aromatic organic solvent
1% up to 50% by weight of polar co-solvent/polar co-solvents
1% up to 12% by weight of an anionic emulsifier

Particular attention may likewise be drawn to formulations of the invention comprising
2% to 6% by weight of deltamethrin and/or beta-cyfluthrin
20% to 30% by weight of surfactant from the group of the alcohol ethoxylates
40% to 70% by weight of aromatic organic solvent
5% to 50% by weight of ethylhexyl lactate
1% to 12% by weight of an anionic emulsifier

The compositions of the invention, in combination with good plant tolerance, favourable toxicity to warm-blooded animals and high compatibility with the environment, are suitable for protecting plants and plant organs, for increasing the harvest yields, for improving the quality of the harvested material and for controlling animal pests, more particularly insects, arachnids, helminths, nematodes and molluscs, which are encountered in agriculture, in horticulture, in animal husbandry, in forests, in gardens and leisure facilities, in the protection of stored products and of materials, and in the hygiene sector. They may be preferably employed as crop protection agents. They are active against normally sensitive and resistant species and against all or some stages of development. The abovementioned pests include:

From the order of the Anoplura (Phthiraptera), for example, Damalinia spp., Haematopinus spp., Linognathus spp., Pediculus spp., Trichodectes spp.

From the class of the Arachnida, for example, Acarus siro, Aceria sheldoni, Aculops spp., Aculus spp., Amblyomma spp., Argas spp., Boophilus spp., Brevipalpus spp., Bryobia praetiosa, Chorioptes spp., Dermanyssus gallinae, Eotetranychus spp., Epitrimerus pyri, Eutetranychus spp., Eriophyes spp., Hemitarsonemus spp., Hyalomma spp., Ixodes spp., Latrodectus mactans, Metatetranychus spp., Oligonychus spp., Omithodoros spp., Panonychus spp., Phyllocoptruta oleivora, Polyphagotarsonemus latus, Psoroptes spp., Rhipicephalus spp., Rhizoglyphus spp., Sarcoptes spp., Scorpio maurus, Stenotarsonemus spp., Tarsonemus spp., Tetranychus spp., Vasates lycopersici.

From the class of the Bivalva, for example, Dreissena spp.

From the order of the Chilopoda, for example, Geophilus spp., Scutigera spp.

From the order of the Coleoptera, for example, Acanthoscelides obtectus, Adoretus spp., Agelastica alni, Agriotes spp., Amphimallon solstitialis, Anobium punctatum, Anoplophora spp., Anthonomus spp., Anthrenus spp., Apogonia spp., Atomaria spp., Attagenus spp., Bruchidius obtectus, Bruchus spp., Ceuthorhynchus spp., Cleonus mendicus, Conoderus spp., Cosmopolites spp., Costelytra zealandica, Curculio spp., Cryptorhynchus lapathi, Dermestes spp., Diabrotica spp., Epilachna spp., Faustinus cubae, Gibbium psylloides, Heteronychus arator, Hylamorpha elegans, Hylotrupes bajulus, Hypera postica, Hypothenemus spp., Lachnosterna consanguinea, Leptinotarsa decemlineata, Lissorhoptrus oryzophilus, Lixus spp., Lyctus spp., Meligethes aeneus, Melolontha melolontha, Migdolus spp., Monochamus spp., Naupactus xanthographus, Niptus hololeucus, Oryctes rhinoceros, Oryzaephilus surinamensis, Otiorrhynchus sulcatus, Oxycetonia jucunda, Phaedon cochleariae, Phyllophaga spp., Popillia japonica, Premnotrypes spp., Psylliodes chrysocephala, Ptinus spp., Rhizobius ventralis, Rhizopertha dominica, Sitophilus spp., Sphenophorus spp., Sternechus spp., Symphyletes spp., Tenebrio molitor, Tribolium spp., Trogoderma spp., Tychius spp., Xylotrechus spp., Zabrus spp.

From the order of the Collembola, for example, Onychiurus armatus.

From the order of the Dermaptera, for example, Forficula auricularia.

From the order of the Diplopoda, for example, Blaniulus guttulatus.

From the order of the Diptera, for example, Aedes spp., Anopheles spp., Bibio hortulanus, Calliphora erythrocephala, Ceratitis capitata, Chrysomyia spp., Cochliomyia spp., Cordylobia anthropophaga, Culex spp., Cuterebra spp., Dacus oleae, Dermatobia hominis, Drosophila spp., Fannia spp., Gastrophilus spp., Hylemyia spp., Hyppobosca spp., Hypoderma spp., Liriomyza spp., Lucilia spp., Musca spp., Nezara spp., Oestrus spp., Oscinella frit, Pegomyia hyoscyami, Phorbia spp., Stomoxys spp., Tabanus spp., Tannia spp., Tipula paludosa, Wohlfahrtia spp.

From the class of the Gastropoda, for example, Arion spp., Biomphalaria spp., Bulinus spp., Deroceras spp., Galba spp., Lymnaea spp., Oncomelania spp., Succinea spp.

From the class of the helminths, for example, Ancylostoma duodenale, Ancylostoma ceylanicum, Acylostoma braziliensis, Ancylostoma spp., Ascaris lubricoides, Ascaris spp., Brugia malayi, Brugia timori, Bunostomum spp., Chabertia spp., Clonorchis spp., Cooperia spp., Dicrocoelium spp, Dictyocaulus filaria, Diphyllobothrium latum, Dracunculus medinensis, Echinococcus granulosus, Echinococcus multilocularis, Enterobius vermicularis, Faciola spp., Haemonchus spp., Heterakis spp., Hymenolepis nana, Hyostrongulus spp., Loa Loa, Nematodirus spp., Oesophagostomum spp., Opisthorchis spp., Onchocerca volvulus, Ostertagia spp., Paragonimus spp., Schistosomen spp., Strongyloides fuelleborni, Strongyloides stercoralis, Stronyloides spp., Taenia saginata, Taenia solium, Trichinella spiralis, Trichinella nativa, Trichinella britovi, Trichinella nelsoni, Trichinella pseudopsiralis, Trichostrongulus spp., Trichuris trichuria, Wuchereria bancrofti.

It is further possible to control protozoa, such as Eimeria.

From the order of the Heteroptera, for example, Anasa tristis, Antestiopsis spp., Blissus spp., Calocoris spp., Campylomma livida, Cavelerius spp., Cimex spp., Creontiades dilutus, Dasynus piperis, Dichelops furcatus, Diconocoris hewetti, Dysdercus spp., Euschistus spp., Eurygaster spp., Heliopeltis spp., Horcias nobilellus, Leptocorisa spp., Leptoglossus phyllopus, Lygus spp., Macropes excavatus, Miridae, Nezara spp., Oebalus spp., Pentomidae, Piesma quadrata, Piezodorus spp., Psallus seriatus, Pseudacysta persea, Rhodnius spp., Sahlbergella singularis, Scotinophora spp., Stephanitis nashi, Tibraca spp., Triatoma spp.

From the order of the Homoptera, for example, Acyrthosipon spp., Aeneolamia spp., Agonoscena spp., Aleurodes spp., Aleurolobus barodensis, Aleurothrixus spp., Amrasca spp., Anuraphis cardui, Aonidiella spp., Aphanostigma piri, Aphis spp., Arboridia apicalis, Aspidiella spp., Aspidiotus spp., Atanus spp., Aulacorthum solani, Bemisia spp., Brachycaudus helichrysii, Brachycolus spp., Brevicoryne brassicae, Calligypona marginata, Cameocephala fulgida, Ceratovacuna lanigera, Cercopidae, Ceroplastes spp., Chaetosiphon fragaefolii, Chionaspis tegalensis, Chlorita onukii, Chromaphis juglandicola, Chrysomphalus ficus, Cicadulina mbila, Coccomytilus halli, Coccus spp., Cryptomyzus ribis, Dalbulus spp., Dialeurodes spp., Diaphorina spp., Diaspis spp., Doralis spp., Drosicha spp., Dysaphis spp., Dysmicoccus spp., Empoasca spp., Eriosoma spp., Erythroneura spp., Euscelis bilobatus, Geococcus coffeae, Homalodisca coagulata, Hyalopterus arundinis, Icerya spp., Idiocerus spp., Idioscopus spp., Laodelphax striatellus, Lecanium spp., Lepidosaphes spp., Lipaphis erysimi, Macrosiphum spp., Mahanarva fimbriolata, Melanaphis sacchari, Metcalfiella spp., Metopolophium dirhodum, Monellia costalis, Monelliopsis pecanis, Myzus spp., Nasonovia ribisnigri, Nephotettix spp., Nilaparvata lugens, Oncometopia spp., Orthezia praelonga, Parabemisia myricae, Paratrioza spp., Parlatoria spp., Pemphigus spp., Peregrinus maidis, Phenacoccus spp., Phloeomyzus passerinii, Phorodon humuli, Phylloxera spp., Pinnaspis aspidistrae, Planococcus spp., Protopulvinaria pyriformis, Pseudaulacaspis pentagona, Pseudococcus spp., Psylla spp., Pteromalus spp., Pyrilla spp., Quadraspidiotus spp., Quesada gigas, Rastrococcus spp., Rhopalosiphum spp., Saissetia spp., Scaphoides titanus, Schizaphis graminum, Selenaspidus articulatus, Sogata spp., Sogatella furcifera, Sogatodes spp., Stictocephala festina, Tenalaphara malayensis, Tinocallis caryaefoliae, Tomaspis spp., Toxoptera spp., Trialeurodes vaporariorum, Trioza spp., Typhlocyba spp., Unaspis spp., Viteus vitifolii.

From the order of the Hymenoptera, for example, Diprion spp., Hoplocampa spp., Lasius spp., Monomorium pharaonis, Vespa spp.

From the order of the Isopoda, for example, Armadillidium vulgare, Oniscus asellus, Porcellio scaber.

From the order of the Isoptera, for example, Reticulitermes spp., Odontotermes spp.

From the order of the Lepidoptera, for example, Acronicta major, Aedia leucomelas, Agrotis spp., Alabama argillacea, Anticarsia spp., Barathra brassicae, Bucculatrix thurberiella, Bupalus piniarius, Cacoecia podana, Capua reticulana, Carpocapsa pomonella, Cheimatobia brumata, Chilo spp., Choristoneura fumiferana, Clysia ambiguella, Cnaphalocerus spp., Earias insulana, Ephestia kuehniella, Euproctis chrysorrhoea, Euxoa spp., Feltia spp., Galleria mellonella, Helicoverpa spp., Heliothis spp., Hofmannophila pseudospretella, Homona magnanima, Hyponomeuta padella, Laphygma spp., Lithocolletis blancardella, Lithophane antennata, Loxagrotis albicosta, Lymantria spp., Malacosoma neustria, Mamestra brassicae, Mocis repanda, Mythimna separata, Oria spp., Oulema oryzae, Panolis flammea, Pectinophora gossypiella, Phyllocnistis citrella, Pieris spp., Plutella xylostella, Prodenia spp., Pseudaletia spp., Pseudoplusia includens, Pyrausta nubilalis, Spodoptera spp., Thermesia gemmatalis, Tinea pellionella, Tineola bisselliella, Tortrix viridana, Trichoplusia spp.

From the order of the Orthoptera, for example, Acheta domesticus, Blatta orientalis, Blattella germanica, Gryllotalpa spp., Leucophaea maderae, Locusta spp., Melanoplus spp., Periplaneta americana, Schistocerca gregaria.

From the order of the Siphonaptera, for example, Ceratophyllus spp., Xenopsylla cheopis.

From the order of the Symphyla, for example, Scutigerella immaculata.

From the order of the Thysanoptera, for example, Baliothrips biformis, Enneothrips flavens, Frankliniella spp., Heliothrips spp., Hercinothrips femoralis, Kakothrips spp., Rhipiphorothrips cruentatus, Scirtothrips spp., Taeniothrips cardamoni, Thrips spp.

From the order of the Thysanura, for example, Lepisma saccharina.

The phytoparasitic nematodes include, for example, Anguina spp., Aphelenchoides spp., Belonoaimus spp., Bursaphelenchus spp., Ditylenchus dipsaci, Globodera spp., Heliocotylenchus spp., Heterodera spp., Longidorus spp., Meloidogyne spp., Pratylenchus spp., Radopholus similis, Rotylenchus spp., Trichodorus spp., Tylenchorhynchus spp., Tylenchulus spp., Tylenchulus semipenetrans, Xiphinema spp.

Compositions of the invention can in addition to at least one pyrethroid comprise other active compounds as well, such as insecticides, attractants, sterilants, bactericides, acaricides, nematicides, fungicides, growth-regulating substances, herbicides, safeners, fertilizers or semiochemicals.

Particularly favourable co-components are, for example, the following components:

### Fungicides:

Inhibitors of nucleic acid synthesis

benalaxyl, benalaxyl-M, bupirimate, chiralaxyl, clozylacon, dimethirimol, ethirimol, furalaxyl, hymexazol, metalaxyl, metalaxyl-M, ofurace, oxadixyl, oxolinic acid

Inhibitors of mitosis and cell division

benomyl, carbendazim, diethofencarb, fuberidazole, pencycuron, thiabendazole, thiophanate-methyl, zoxamide

Inhibitors of respiratory chain complex I

diflumetorim

Inhibitors of respiratory chain complex II

boscalid, carboxin, fenfuram, flutolanil, furametpyr, mepronil, oxycarboxin, penthiopyrad, thifluzamide

Inhibitors of respiratory chain complex III

azoxystrobin, cyazofamid, dimoxystrobin, enestrobin, famoxadone, fenamidone, fluoxastrobin, kresoxim-methyl, metominostrobin, orysastrobin, pyraclostrobin, picoxystrobin, trifloxystrobin

Decouplers

dinocap, fluazinam

Inhibitors of ATP production

fentin acetate, fentin chloride, fentin hydroxide, silthiofam

Inhibitors of amino acid biosynthesis and protein biosynthesis

andoprim, blasticidin-S, cyprodinil, kasugamycin, kasugamycin hydrochloride hydrate, mepanipyrim, pyrimethanil

Inhibitors of signal transduction

fenpiclonil, fludioxonil, quinoxyfen

Inhibitors of lipid and membrane synthesis

chlozolinate, iprodione, procymidone, vinclozolin

ampropylfos, potassium-ampropylfos, edifenphos, iprobenfos (IBP), isoprothiolane, pyrazophos

tolclofos-methyl, biphenyl

iodocarb, propamocarb, propamocarb hydrochloride

Inhibitors of ergosterol biosynthesis

fenhexamid,

azaconazole, bitertanol, bromuconazole, cyproconazole, diclobutrazole, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, paclobutrazole, penconazole, propiconazole, prothioconazole, simeconazole, tebuconazole, tetraconazole, triadimefon, triadimenol, triticonazole, uniconazole, voriconazole, imazalil, imazalil sulphate, oxpoconazole, fenarimol, flurprimidole, nuarimol, pyrifenox, triforine, pefurazoate, prochloraz, triflumizole, viniconazole,

aldimorph, dodemorph, dodemorph acetate, fenpropimorph, tridemorph, fenpropidin, spiroxamine,

naftifine, pyributicarb, terbinafine

Inhibitors of cell wall synthesis

benthiavalicarb, bialaphos, dimethomorph, flumorph, iprovalicarb, polyoxins, polyoxorim, validamycin A

Inhibitors of melanin biosynthesis

capropamid, diclocymet, fenoxanil, phthalid, pyroquilon, tricyclazole

Resistance induction

acibenzolar-S-methyl, probenazole, tiadinil

Multisite

captafol, captan, chlorothalonil, copper salts such as: copper hydroxide, copper naphthenate, copper oxychloride, copper sulphate, copper oxide, oxine-copper and Bordeaux mixture, dichlofluanid, dithianon, dodine, dodine free base, ferbam, folpet, fluorofolpet, guazatine, guazatine acetate, iminoctadine, iminoctadine albesilate, iminoctadine triacetate, mancopper, mancozeb, maneb, metiram, metiram zinc, propineb, sulphur and sulphur preparations containing calcium polysulphide, thiram, tolylfluanid, zineb, ziram

Unknown mechanism amibromdol, benthiazole, bethoxazin, capsimycin, carvone, chinomethionat, chloropicrin, cufraneb, cyflufenamid, cymoxanil, dazomet, debacarb, diclomezine, dichlorophen, dicloran, difenzoquat, difenzoquat methyl sulphate, diphenylamine, ethaboxam, ferimzone, flumetover, flusulphamide, fluopicolide, fluoroimide, hexachlorobenzene, 8-hydroxyquinoline sulphate, irumamycin, methasulphocarb, metrafenone, methyl isothiocyanate, mildiomycin, natamycin, nickel dimethyl dithiocarbamate, nitrothal-isopropyl, octhilinone, oxamocarb, oxyfenthiin, pentachlorophenol and salts, 2-phenylphenol and salts, piperalin, propanosine-sodium, proquinazid, pyrrolenitrin, quintozene, tecloftalam, tecnazene, triazoxide, trichlamide, zarilamid and 2,3,5,6-tetrachloro-4-(methylsulphonyl)pyridine, N-(4-chloro-2-nitrophenyl)-N-ethyl-4-methylbenzenesulphonamide, 2-amino-4-methyl-N-phenyl-5-thiazolecarboxamide, 2-chloro-N-(2,3-dihydro-1,1,3-trimethyl-1H-inden-4-yl)-3-pyridinecarboxamide, 3-[5-(4-chloro-phenyl)-2,3-dimethylisoxazolidin-3-yl]pyridine, cis-1-(4-chlorophenyl)-2-( 1H-1,2,4-triazol-1-yl) cycloheptanol, 2,4-dihydro-5-methoxy-2-methyl4-[[[[1 -[3-(trifluoromethyl)phenyl]-ethylidene]amino]oxy]methyl]phenyl]-3H-1,2,3-triazol-3-one (185336-79-2), methyl 1-(2,3-dihydro-2,2-dimethyl-1H-inden-1-yl)-1H-imidazole-5-carboxylate, 3,4,5-trichloro-2,6-pyridinedicarbonitrile, methyl 2-[[[cyclopropyl[(4-methoxyphenyl)imino]methyl]thio]methyl]-.alpha.-(methoxymethylene) benzacetate, 4-chloro-alpha-propynyloxy-N-[2-[3-methoxy4-(2-propynyloxy) phenyl]ethyl]benzacetamide, (2S)-N-[2-[4-[[3-(4-chlorophenyl)-2-propynyl]oxy]-3-methoxyphenyl ]ethyl]-3-methyl-2-[(methylsulphonyl)amino]butanamide, 5-chloro-7-(4-methylpiperidin-1-yl)-6-(2,4,6-trifluorophenyl) [1,2,4]triazolo[1,5-a]pyrimidine, 5-chloro-6-(2,4,6-trifluorophenyl)-N-[(1R)-1,2,2-trimethylpropyl][1,2,4]triazolo[1,5-a]pyrimidin-7-amine, 5-chloro-N-[(1R)-1,2-dimethylpropyl]-6-(2,4,6-trifluorophenyl)[1,2,4]triazolo[1,5-a]pyrimidin-7-amine, N-[1-(5-bromo-3-chloropyridin-2-yl)ethyl]-2,4-dichloronicotinamide, N-(5-bromo-3-chloropyridin-2-yl) methyl-2,4-dichloronicotinamide, 2-butoxy-6-iodo-3-propylbenzopyranon-4-one, N-{(Z)-[(cyclopropylmethoxy)imino][6-(difluoromethoxy)-2,3-difluorophenyl]methyl}-2-benzacetamide, N-(3-ethyl-3,5,5-trimethylcyclohexyl)-3-formylamino-2-hydroxybenzamide, 2-[[[[1-[3(1-fluoro-2-phenylethyl)oxy]phenyl]ethylidene]amino]oxy]methyl]-alpha-(methoxy-imino)-N-methyl-alphaE-benzacetamide, N-{2-[3-chloro-5-(trifluoromethyl)pyridin-2-yl]-ethyl}-2-(trifluoromethyl) benzamide, N-(3′,4′-dichloro-5-fluorobiphenyl-2-yl)-3-(difluoro-methyl)-1-methyl-1H-pyrazole-4-carboxamide, N-(6-methoxy-3-pyridinyl)cyclopropane-carboxamide, 1-[(4-methoxyphenoxy)methyl]-2,2-dimethylpropyl-1H-imidazole-1-carboxylic acid, O-[1-[(4-methoxyphenoxy)methyl]-2,2-dimethylpropyl]-1H-imidazole-1-carbothioic acid, 2-(2-{[6-(3-chloro-2-methylphenoxy)-5-fluoropyrimdin-4-yl]oxy}phenyl)-2-(methoxyimino)-N-methylacetamide

### Bactericides:

bronopol, dichlorophen, nitrapyrin, nickel dimethyldithiocarbamate, kasugamycin, octhilinone, furancarboxylic acid, oxytetracycline, probenazole, streptomycin, tecloftalam, copper sulphate and other copper preparations.

### Insecticides/acaricides/nematicides:

Acetylcholin esterase (AChE) inhibitors

carbamates, for example alanycarb, aldicarb, aldoxycarb, allyxycarb, aminocarb, bendiocarb, benfuracarb, bufencarb, butacarb, butocarboxim, butoxycarboxim, carbaryl, carbofuran, carbosulfan, cloethocarb, dimetilan, ethiofencarb, fenobucarb, fenothiocarb, formetanate, furathiocarb, isoprocarb, metam-sodium, methiocarb, methomyl, metolcarb, oxamyl, pirimicarb, promecarb, propoxur, thiodicarb, thiofanox, trimethacarb, XMC, xylylcarb, triazamate

organophosphates, for example acephate, azamethiphos, azinphos (-methyl, -ethyl), bromophos-ethyl, bromfenvinfos (-methyl), butathiofos, cadusafos, carbophenothion, chlorethoxyfos, chlorfenvinphos, chlormephos, chlorpyrifos (-methyl/-ethyl), coumaphos, cyanofenphos, cyanophos, chlorfenvinphos, demeton-S-methyl, demeton-S-methylsulphone, dialifos, diazinon, dichlofenthion, dichlorvos/DDVP, dicrotophos, dimethoate, dimethylvinphos, dioxabenzofos, disulfoton, EPN, ethion, ethoprophos, etrimfos, famphur, fenamiphos, fenitrothion, fensulfothion, fenthion, flupyrazofos, fonofos, formothion, fosmethilan, fosthiazate, heptenophos, iodofenphos, iprobenfos, isazofos, isofenphos, isopropyl O-salicylate, isoxathion, malathion, mecarbam, methacrifos, methamidophos, methidathion, mevinphos, monocrotophos, naled, omethoate, oxydemeton-methyl, parathion (-methyl/-ethyl), phenthoate, phorate, phosalone, phosmet, phosphamidon, phosphocarb, phoxim, pirimiphos (-methyl/-ethyl), profenofos, propaphos, propetamphos, prothiofos, prothoate, pyraclofos, pyridaphenthion, pyridathion, quinalphos, sebufos, sulphotep, sulprofos, tebupirimfos, temephos, terbufos, tetrachlorvinphos, thiometon, triazophos, triclorfon, vamidothion

Sodium channel modulators / voltage-dependent sodium channel blockers

DDT

oxadiazines, for example indoxacarb

semicarbazone, for example metaflumizone (BAS3201)

Acetylcholine receptor agonists/antagonists

chloronicotinyls, for example acetamiprid, clothianidin, dinotefuran, imidacloprid, nitenpyram, nithiazine, thiacloprid, thiamethoxam

nicotine, bensultap, cartap

Acetylcholine receptor modulators

spinosyns, for example spinosad,

GABA-gated chloride channel antagonists

organochlorines, for example camphechlor, chlordane, endosulfan, gamma-HCH, HCH, heptachlor, lindane, methoxychlor

fiproles, for example acetoprole, ethiprole, fipronil, pyrafluprole, pyriprole, vaniliprole

Chloride channel activators

mectins,

for example abamectin, emamectin, emamectin-benzoate, ivermectin, lepimectin, milbemycin

Juvenile hormone mimetics, for example diofenolan, epofenonane, fenoxycarb, hydroprene, kinoprene, methoprene, pyriproxifen, triprene

Ecdysone agonists/disruptors

diacylhydrazines, for example chromafenozide, halofenozide, methoxyfenozide, tebufenozide

Chitin biosynthesis inhibitors

benzoylureas, for example bistrifluron, chlofluazuron, diflubenzuron, fluazuron, flucycloxuron, flufenoxuron, hexaflumuron, lufenuron, novaluron, noviflumuron, penfluron, teflubenzuron, triflumuron

buprofezin

cyromazine

Oxidative phosphorylation inhibitors, ATP disruptors

diafenthiuron

organotin compounds, for example azocyclotin, cyhexatin, fenbutatin oxide

Oxidative phosphorylation decouplers acting by interrupting the H-proton gradient

pyrroles, for example chlorfenapyr

dinitrophenols, for example binapacyrl, dinobuton, dinocap, DNOC

Site-I electron transport inhibitors

METIs, for example fenazaquin, fenpyroximate, pyrimidifen, pyridaben, tebufenpyrad, tolfenpyrad

hydramethylnon

dicofol

Site-II electron transport inhibitors

rotenone

Site-III electron transport inhibitors

acequinocyl, fluacrypyrim

Microbial disruptors of the insect gut membrane

Bacillus thuringiensis strains

Lipid synthesis inhibitors

tetronic acids,

for example spirodiclofen, spiromesifen

tetramic acids, for example spirotetramat, cis-3-(2,5-dimethylphenyl)-4-hydroxy-8-methoxy-1-aza-spiro [4.5]dec-3-en-2-one

carboxamides, for example flonicamid

octopaminergic agonists, for example amitraz

Inhibitors of magnesium-stimulated ATPase,

propargite

nereistoxin analogues, for example thiocyclam hydrogen oxalate, thiosultap-sodium

Ryanodin receptor agonists

benzoic acid dicarboxamides, for example flubendiamide

anthranilamides, for example rynaxypyr (3-bromo-N-{4-chloro-2-methyl-6-[(methylamino)carbonyl]phenyl}-1-(3-chloropyridin-2-yl)-1H-pyrazole-5-carboxamide)

Biologicals, hormones or pheromones

azadirachtin, Bacillus spec., Beauveria spec., codlemone, Metarrhizium spec., Paecilomyces spec., thuringiensin, Verticillium spec.

Active compounds with unknown or non-specific mechanisms of action

fumigants, for example aluminium phosphide, methyl bromide, sulphuryl fluoride

antifeedants, for example cryolite, flonicamid, pymetrozine

mite growth inhibitors, for example clofentezine, etoxazole, hexythiazox

amidoflumet, benclothiaz, benzoximate, bifenazate, bromopropylate, buprofezin, chinomethionat, chlordimeform, chlorobenzilate, chloropicrin, clothiazoben, cycloprene, cyflumetofen, dicyclanil, fenoxacrim, fentrifanil, flubenzimine, flufenerim, flutenzin, gossyplure, hydramethylnone, japonilure, metoxadiazone, petroleum, piperonyl butoxide, potassium oleate, pyridalyl, sulfluramid, tetradifon, tetrasul, triarathene, verbutin

The compositions of the invention can further comprise synergists. Synergists are compounds which boost the action of the active compounds, without it being necessary for the synergist added to be active itself.

The compositions of the invention can further comprise inhibitors which reduce degradation of the active compound after deployment in the environment of the plant, on the surface of parts of plants or in plant tissues.

The formulation is employed in a customary manner adapted to it.

All plants and plant parts can be treated in accordance with the invention. Plants are to be understood as meaning in the present context all plants and plant populations, such as desired and unwanted wild plants or crop plants (including naturally occurring crop plants). Crop plants can be plants which can be obtained by conventional plant breeding and optimization methods or by biotechnological and genetic engineering methods or by combinations of these methods, including the transgenic plants and including the plant cultivars protectable or not protectable by varietal property rights. Plant parts are to be understood as meaning all parts and organs of plants above and below the ground, such as shoot, leaf, flower and root, examples which may be mentioned being leaves, needles, stalks, stems, flowers, fruit bodies, fruits, seeds, roots, tubers and rhizomes. The plant parts also include harvested material, and vegetative and generative propagation material, for example cuttings, tubers, rhizomes, offshoots and seeds.

Treatment according to the invention of the plants and plant parts with the compositions is carried out directly or by allowing the compositions to act on the surroundings, habitat or storage space by the customary treatment methods, for example by immersion, spraying, fogging, painting on, or injecting.

As already mentioned above, it is possible to treat all plants and their parts according to the invention. In a preferred embodiment, wild plant species and plant cultivars, or those obtained by conventional biological breeding methods, such as crossing or protoplast fusion, and parts thereof, are treated. In a further preferred embodiment, transgenic plants and plant cultivars obtained by genetic engineering methods, if appropriate in combination with conventional methods (Genetically Modified Organisms), and parts thereof are treated. The terms “parts”, “parts of plants” and “plant parts” have been explained above.

With particular preference, plants of the plant cultivars which are in each case commercially available or in use are treated according to the invention. Plant cultivars are to be understood as meaning plants having novel properties (“traits”) which have been obtained by conventional breeding, by mutagenesis or by recombinant DNA techniques. They can be cultivars, bio- and genotypes.

Depending on the plant species or plant cultivars, their location and growth conditions (soils, climate, vegetation period, diet), the treatment according to the invention may also result in superadditive (“synergistic”) effects. Thus, for example, reduced application rates and/or expansions of the activity spectrum and/or a boost to the activity of the compositions of the invention, better plant growth, increased tolerance to high or low temperatures, increased tolerance to drought or to water or soil salt content, increased flowering performance, easier harvesting, accelerated maturation, higher harvest yields, higher quality and/or higher nutritional value of the harvested products, better keeping properties and/or processability of the harvested products are possible, which exceed the effects which were actually to be expected.

The transgenic plants or plant cultivars (obtained by genetic engineering) which are preferably to be treated according to the invention include all plants which, by virtue of the genetic modification, received genetic material which imparts particularly advantageous, useful traits to these plants. Examples of such traits are better plant growth, increased tolerance to high or low temperatures, increased tolerance to drought or to water or soil salt content, increased flowering performance, easier harvesting, accelerated maturation, higher harvest yields, higher quality and/or a higher nutritional value of the harvested products, better keeping properties and/or processability of the harvested products. Further and particularly emphasized examples of such traits are a better defence of the plants against animal and microbial pests, such as against insects, mites, phytopathogenic fungi, bacteria and/or viruses, and also increased tolerance of the plants to certain herbicidally active compounds. Examples of transgenic plants which may be mentioned are the important crop plants, such as cereals (wheat, rice), maize, soya beans, potatoes, sugar beet, tomatoes, peas and other vegetable varieties, cotton, tobacco, oilseed rape and also fruit plants (with the fruits apples, pears, citrus fruits and grapes), and particular emphasis is given to maize, soya beans, potatoes, cotton, tobacco and oilseed rape. Traits that are emphasized in particular are increased defence of the plants against insects, arachnids, nematodes and slugs and snails by virtue of toxins formed in the plants, in particular those formed in the plants by the genetic material from Bacillus thuringiensis (for example by the genes CryIA(a), CryIA(b), CryIA(c), CryIIA, CryIIIA, CryIIIA, CryIIIB2, Cry9c, Cry2Ab, Cry3Bb and CryIF and also combinations thereof) (referred to hereinbelow as “Bt plants”). Traits that are also particularly emphasized are the increased defence of the plants against fungi, bacteria and viruses by systemic acquired resistance (SAR), systemin, phytoalexins, elicitors and resistance genes and correspondingly expressed proteins and toxins. Traits that are further particularly emphasized are the increased tolerance of the plants to certain herbicidally active compounds, for example imidazolinones, sulphonylureas, glyphosate or phosphinotricin (for example the “PAT” gene). The genes which impart the desired traits in question can also be present in combination with one another in the transgenic plants. Examples of “Bt plants” which may be mentioned are maize varieties, cotton varieties, soya bean varieties and potato varieties which are sold under the trade names YIELD GARD® (for example maize, cotton, soya beans), KnockOut® (for example maize), StarLink® (for example maize), Bollgard® (cotton), Nucotn® (cotton) and NewLeaf® (potato). Examples of herbicide-tolerant plants which may be mentioned are maize varieties, cotton varieties and soya bean varieties which are sold under the trade names Roundup Ready® (tolerance to glyphosate, for example maize, cotton, soya beans), Liberty Link( (tolerance to phosphinotricin, for example oilseed rape), IMI® (tolerance to imidazolinones) and STS(® (tolerance to sulphonylureas, for example maize). Herbicide-resistant plants (plants bred in a conventional manner for herbicide tolerance) which may be mentioned include the varieties sold under the name Clearfield® (for example maize). Of course, these statements also apply to plant cultivars which have these genetic traits, or genetic traits still to be developed, and which will be developed and/or marketed in the future.

The plants listed can be treated according to the invention in a particularly advantageous manner with the compositions of the invention. The preferred ranges stated above also apply to the treatment of these plants. Particular emphasis is given to the treatment of plants with the composition specifically mentioned in the present text.

The compositions of the invention act not only against plant, hygiene and stored product pests, but also in the veterinary medicine sector against animal parasites (ecto- and endoparasites), such as hard ticks, soft ticks, mange mites, leaf mites, flies (biting and licking), parasitic fly larvae, lice, hair lice, feather lice and fleas. These parasites include:

From the order of the Anoplurida, for example, Haematopinus spp., Linognathus spp., Pediculus spp., Phtirus spp., Solenopotes spp.

From the order of the Mallophagida and the suborders Amblycerina and Ischnocerina, for example, Trimenopon spp., Menopon spp., Trinoton spp., Bovicola spp., Wemeckiella spp., Lepikentron spp., Damalina spp., Trichodectes spp., Felicola spp.

From the order of the Diptera and the suborders Nematocerina and Brachycerina, for example, Aedes spp., Anopheles spp., Culex spp., Simulium spp., Eusimulium spp., Phlebotomus spp., Lutzomyia spp., Culicoides spp., Chrysops spp., Hybomitra spp., Atylotus spp., Tabanus spp., Haematopota spp., Philipomyia spp., Braula spp., Musca spp., Hydrotaea spp., Stomoxys spp., Haematobia spp., Morellia spp., Fannia spp., Glossina spp., Calliphora spp., Lucilia spp., Chrysomyia spp., Wohlfahrtia spp., Sarcophaga spp., Oestrus spp., Hypoderma spp., Gasterophilus spp., Hippobosca spp., Lipoptena spp., Melophagus spp.

From the order of the Siphonapterida, for example, Pulex spp., Ctenocephalides spp., Xenopsylla spp., Ceratophyllus spp.

From the order of the Heteropterida, for example, Cimex spp., Triatoma spp., Rhodnius spp., Panstrongylus spp.

From the order of the Blattarida, for example, Blatta orientalis, Periplaneta americana, Blattela germanica, Supella spp.

From the subclass of the Acari (Acarina) and the orders of the Meta- and Mesostigmata, for example, Argas spp., Omithodorus spp., Otobius spp., Ixodes spp., Amblyomma spp., Boophilus spp., Dermacentor spp., Haemophysalis spp., Hyalomma spp., Rhipicephalus spp., Dermanyssus spp., Raillietia spp., Pneumonyssus spp., Stemostoma spp., Varroa spp.

From the order of the Actinedida (Prostigmata) and Acaridida (Astigmata), for example, Acarapis spp., Cheyletiella spp., Omithocheyletia spp., Myobia spp., Psorergates spp., Demodex spp., Trombicula spp., Listrophorus spp., Acarus spp., Tyrophagus spp., Caloglyphus spp., Hypodectes spp., Pterolichus spp., Psoroptes spp., Chorioptes spp., Otodectes spp., Sarcoptes spp., Notoedres spp., Knemidocoptes spp., Cytodites spp., Laminosioptes spp.

The compositions of the invention are also suitable for controlling arthropods which infest agricultural livestock, such as, for example, cattle, sheep, goats, horses, pigs, donkeys, camels, buffalo, rabbits, chickens, turkeys, ducks, geese and bees, other pets, such as, for example, dogs, cats, caged birds and aquarium fish, and also so-called test animals, such as, for example, hamsters, guinea pigs, rats and mice. By controlling these arthropods, cases of death and reduction in productivity (for meat, milk, wool, hides, eggs, honey etc.) should be diminished, so that more economic and easier animal husbandry is possible by use of the compositions of the invention.

It has furthermore been found that the compositions of the invention have a strong insecticidal action against insects which destroy industrial materials.

The following insects may be mentioned as examples and as preferred—but without any limitation:

Beetles such as Hylotrupes bajulus, Chlorophorus pilosis, Anobium punctatum, Xestobium rufovillosum, Ptilinus pecticomis, Dendrobium pertinex, Emobius mollis, Priobium carpini, Lyctus brunneus, Lyctus africanus, Lyctus planicollis, Lyctus linearis, Lyctus pubescens, Trogoxylon aequale, Minthes rugicollis, Xyleborus spec. Tryptodendron spec. Apate monachus, Bostrychus capucins, Heterobostrychus brunneus, Sinoxylon spec. Dinoderus minutus;

Hymenopterons such as Sirex juvencus, Urocerus gigas, Urocerus gigas taignus, Urocerus augur;

Termites such as Kalotermes flavicollis, Cryptotermes brevis, Heterotermes indicola, Reticulitermes flavipes, Reticulitermes santonensis, Reticulitermes lucifugus, Mastotermes darwiniensis, Zootermopsis nevadensis, Coptotermes formosanus;

Bristletails such as Lepisma saccharina.

Industrial materials in the present context are to be understood as meaning non-living materials, such as, preferably, plastics, adhesives, sizes, papers and cardboards, leather, wood and processed wood products and coating compositions.

The ready-to-use compositions may also, if appropriate, comprise further insecticides and, if appropriate, one or more fungicides.

With respect to possible additional co-additives, reference may be made to the insecticides and fungicides specified above.

The compositions of the invention can likewise be employed for protecting objects which come into contact with saltwater or brackish water, in particular hulls, screens, nets, buildings, moorings and signalling systems, against fouling.

Furthermore, the compositions of the invention, alone or in combinations with other active compounds, may be employed as antifouling agents.

In domestic, hygiene and stored-product protection, the compositions are also suitable for controlling animal pests, particularly insects, arachnids and mites, which are found in enclosed spaces such as, for example, dwellings, factory halls, offices, vehicle cabins and the like. They can be employed alone or in combination with other active compounds and auxiliaries in domestic insecticide products for controlling these pests. They are active against sensitive and resistant species and against all developmental stages. These pests include:

From the order of the Scorpionidea, for example, Buthus occitanus.

From the order of the Acarina, for example, Argas persicus, Argas reflexus, Bryobia ssp., Dermanyssus gallinae, Glyciphagus domesticus, Omithodorus moubat, Rhipicephalus sanguineus, Trombicula alfreddugesi, Neutrombicula autumnalis, Dermatophagoides pteronissimus, Dermatophagoides forinae.

From the order of the Araneae, for example, Aviculariidae, Araneidae.

From the order of the Opiliones, for example, Pseudoscorpiones chelifer, Pseudoscorpiones cheiridium, Opiliones phalangium.

From the order of the Isopoda, for example, Oniscus asellus, Porcellio scaber.

From the order of the Diplopoda, for example, Blaniulus guttulatus, Polydesmus spp.

From the order of the Chilopoda, for example, Geophilus spp.

From the order of the Zygentoma, for example, Ctenolepisma spp., Lepisma saccharina, Lepismodes inquilinus.

From the order of the Blattaria, for example, Blatta orientalies, Blattella germanica, Blattella asahinai, Leucophaea maderae, Panchlora spp., Parcoblatta spp., Periplaneta australasiae, Periplaneta americana, Periplaneta brunnea, Periplaneta fuliginosa, Supella longipalpa.

From the order of the Saltatoria, for example, Acheta domesticus.

From the order of the Dermaptera, for example, Forficula auricularia.

From the order of the Isoptera, for example, Kalotermes spp., Reticulitermes spp.

From the order of the Psocoptera, for example, Lepinatus spp., Liposcelis spp.

From the order of the Coleoptera, for example, Anthrenus spp., Attagenus spp., Dermestes spp., Latheticus oryzae, Necrobia spp., Ptinus spp., Rhizopertha dominica, Sitophilus granarius, Sitophilus oryzae, Sitophilus zeamais, Stegobium paniceum.

From the order of the Diptera, for example, Aedes aegypti, Aedes albopictus, Aedes taeniorhynchus, Anopheles spp., Calliphora erythrocephala, Chrysozona pluvialis, Culex quinquefasciatus, Culex pipiens, Culex tarsalis, Drosophila spp., Fannia canicularis, Musca domestica, Phlebotomus spp., Sarcophaga carnaria, Simulium spp., Stomoxys calcitrans, Tipula paludosa.

From the order of the Lepidoptera, for example, Achroia grisella, Galleria mellonella, Plodia interpunctella, Tinea cloacella, Tinea pellionella, Tineola bisselliella.

From the order of the Siphonaptera, for example, Ctenocephalides canis, Ctenocephalides felis, Pulex irritans, Tunga penetrans, Xenopsylla cheopis.

From the order of the Hymenoptera, for example, Camponotus herculeanus, Lasius fuliginosus, Lasius niger, Lasius umbratus, Monomorium pharaonis, Paravespula spp., Tetramorium caespitum.

From the order of the Anoplura, for example, Pediculus humanus capitis, Pediculus humanus corporis, Pemphigus spp., Phylloera vastatrix, Phthirus pubis.

From the order of the Heteroptera, for example, Cimex hemipterus, Cimex lectularius, Rhodinus prolixus, Triatoma infestans.

In the field of domestic insecticides, they are used alone or in combination with other suitable active compounds, such as phosphoric esters, carbamates, neonicotinoids, growth regulators or active compounds from other known classes of insecticides.

### PREPARATION EXAMPLES

| | 1 | 2 | 3 | 4 | 5 | 6 | 7 | 8 | 9 | 10 |
|---|---|---|---|---|---|---|---|---|---|---|
| Deltamethrin | 2.6 | 2.6 | 2.6 | 2.6 | 2.6 | 2.6 | 2.6 | 2.6 | 2.6 | 2.6 |
| (I-a-1) | 24 | 24 | 24 | 24 | 48 | | 24 | 24 | 24 | 24 |
| (I-a-2) | | | | | | 48 | | | | |
| EHL | | 10 | 24 | | | | | 10 | | 10 |
| Gamma- | | | | 25 | 25 | | 5 | | 5 | |
| butyrolactone | | | | | | | | | | |
| Ethylhexyl | | | | 24 | | | | | | |
| palmitate | | | | | | | | | | |
| Phenylsulphonate | 6 | 6 | 6 | 6 | 6 | 6 | | | | |
| CA | | | | | | | | | | |
| Phenylsulphonate | | | | | | | 6 | 6 | 6 | 6 |
| CAL | | | | | | | | | | |
| Dimethyl- | | | | | | | | | 0.01 | 0.01 |
| polysiloxane | | | | | | | | | | |

All formulations are made up with solvent (Solvesso®).

All figures in % by weight

### Use Examples

### Example A

### Heliothis Armigera Test

An appropriate application solution is produced by mixing the desired proportion of formulated product with water to the desired concentration.

Cotton plants (Gossypium herbaceum) are sprayed with the application solution at the desired concentration and, after the spray coating has dried on, are populated with the 2nd or 3rd larval stage of the cotton budworm (Heliothis armigera).

After the desired time the effect in % is determined. 100% here means that all of the caterpillars have been killed; 0% means that no caterpillar has been killed.

Superior activity over the prior art was displayed in this test, for example, by the following formulations of the preparation examples: formulations 1, 2 and 3

TABLE A1
Heliothis armigera test, 2nd larval stage

| | Active compound | Kill level |
|---|---|---|
| Formulation | concentration in g ac/ha | in % after 1^{d} |
| Formulation 1 | 7.5 | 90 |
| inventive | | |
| Formulation 2 | 7.5 | 80 |
| inventive | | |
| Formulation 3 | 7.5 | 90 |
| inventive | | |
| Decis ® EC 025 Standard | 7.5 | 50 |
| Prior art | | |

TABLE A2
Heliothis armigera test, 3rd larval stage

| | Active compound | Kill level |
|---|---|---|
| Formulation | concentration in g ac/ha | in % after 2^{h} |
| Formulation 1 | 3.75 | 40 |
| inventive | | |
| Formulation 2 | 3.75 | 50 |
| inventive | | |
| Formulation 3 | 3.75 | 30 |
| inventive | | |
| Decis ® EC 025 Standard | 3.75 | 10 |
| Prior art | | |

### Example B

### Adult Phaedon Cochleariae Test

An appropriate application solution is produced by mixing the desired proportion of formulated product with water to the desired concentration.

Cabbage plants (Brassica oleracea) are sprayed with the application solution at the desired concentration and, after the coating has dried on, are populated with adults of the mustard beetle (Phaedon cochleariae).

After the desired time the effect in % is determined. 100% here means that all of the beetles have been killed; 0% means that no beetle has been killed.

Superior activity over the prior art in this test was displayed, for example, by the following formulations of the preparation examples: formulations 1, 2 and 3

TABLE B1
Phaedon cochleariae test, beetle test

| | Active compound | Kill level |
|---|---|---|
| Formulation | concentration in g ac/ha | in % after 3^{d} |
| Formulation 1 | 3.75 | 90 |
| inventive | | |
| Formulation 2 | 3.75 | 90 |
| inventive | | |
| Decis ® EC 025 Standard | 3.75 | 60 |
| Prior art | | |

TABLE B2
Phaedon cochleariae test, beetle test

| | Active compound | Kill level |
|---|---|---|
| Formulation | concentration in g ac/ha | in % after 1^{d} |
| Formulation 1 | 7.5 | 70 |
| inventive | | |
| Formulation 3 | 7.5 | 90 |
| inventive | | |
| Decis ® EC 025 Standard | 7.5 | 50 |
| Prior art | | |

### Example C

### Spodoptera Frugiperda Test

An appropriate application solution is produced by mixing the desired proportion of formulated product with water to the desired concentration.

Maize plants (Zea mays) are sprayed with the application solution at the desired concentration and, after the spray coating has dried on, are populated with the 2nd or 3rd larval stage of the armyworm (Spodoptera frugiperda).

After the desired time the effect in % is determined. 100% here means that all of the caterpillars have been killed; 0% means that no caterpillar has been killed.

Superior activity over the prior art was displayed in this test, for example, by the following formulations of the preparation examples: formulations 1, 2 and 3

TABLE C1
Spodoptera frugiperda test, 2nd larval stage

| | Active compound | Kill level |
|---|---|---|
| Formulation | concentration in g ac/ha | in % after 2^{d} |
| Formulation 1 | 7.5 | 90 |
| inventive | | |
| Formulation 2 | 7.5 | 100 |
| inventive | | |
| Formulation 3 | 7.5 | 100 |
| inventive | | |
| Decis ® EC 025 Standard | 7.5 | 70 |
| Prior art | | |

TABLE C2
Spodoptera frugiperda test, 3rd larval stage

| | Active compound | Kill level |
|---|---|---|
| Formulation | concentration in g ac/ha | in % after 2^{d} |
| Formulation 1 | 7.5 | 100 |
| inventive | | |
| Formulation 2 | 7.5 | 100 |
| inventive | | |
| Formulation 3 | 7.5 | 100 |
| inventive | | |
| Decis ® EC 025 Standard | 7.5 | 70 |
| Prior art | | |

### Example D

### Metopolophium Dirhodum

An appropriate application solution is produced by mixing the desired proportion of formulated product with water to the desired concentration.

Barley plants (Hordeum vulgare) heavily infested with a mixed population of cereal aphids (Metopolophium dirhodum) are sprayed with the application solution at the desired concentration.

After the desired time the effect in % is determined. 100% here means that all aphids have been killed; 0% means that no aphids have been killed.

Superior activity over the prior art in this test was displayed, for example, by the following formulations of the preparation examples: formulations 1, 4, 5 and 6

TABLE D1
Phytopathogenic insects
Metopolophium dirhodum test

| | Active compound | Kill level |
|---|---|---|
| Formulation | concentration in g ac/ha | in % after 2^{h} |
| Formulation 4 | 3.125 | 35 |
| Formulation 1 | 3.125 | 35 |
| Formulation 5 | 3.125 | 40 |
| Decis ® EC 025 Standard | 3.125 | 20 |
| Prior art | | |

TABLE D2
Phytopathogenic insects
Metopolophium dirhodum test

| | Active compound | Kill level |
|---|---|---|
| Formulation | concentration in g ac/ha | in % after 3^{d} |
| Formulation 6 | 3.125 | 57 |
| Decis ® EC 025 Standard | 3.125 | 43 |
| Prior art | | |

### Example E

### Rain Resistance: Sitobion Avenae

An appropriate application solution is produced by mixing the desired proportion of formulated product with water to the desired concentration.

Barley plants (Hordeum vulgare) are sprayed with the application solution at the desired concentration and, after the coating has dried on, are irrigated by sprinkling with different amounts of water.

After the plants have dried off, the leaves are populated with a mixed population of cereal aphids (Sitobion avenae).

After the desired time the effect in % is determined. 100% here means that all aphids have been killed; 0% means that no aphids have been killed.

Superior rain resistance over the prior art in this test is displayed, for example, by the following formulations of the preparation examples:

TABLE E1
Rain resistance 6.35 l/m³: Sitobion avenae test

| | Active compound | Kill level |
|---|---|---|
| Formulation | concentration in g ac/ha | in % after 1^{d} |
| Formulation 7 | 15 | 80 |
| inventive | | |
| Formulation 8 | 15 | 65 |
| inventive | | |
| Decis ® EC 025 Standard | 15 | 20 |
| Prior art | | |

Formulations 9 and 10 display greatly reduced foaming with otherwise identical behaviour.

TABLE E2
Rain resistance 20 l/m³: Sitobion avenae test

| | Active compound | Kill level |
|---|---|---|
| Formulation | concentration in g ac/ha | in % after 2^{d} |
| Formulation 7 | 15 | 95 |
| inventive | | |
| Formulation 8 | 15 | 70 |
| inventive | | |
| Decis ® EC 025 Standard | 15 | 60 |
| Prior art | | |

Formulations 9 and 10 display greatly reduced foaming with otherwise identical behaviour.

1. A composition comprising
at least one pyrethroid,
at least one surfactant and
at least one water-immiscible solvent.

2. A composition according to claim 1, comprising beta-cyfluthrin, deltamethrin or a combination thereof.

3. A composition according to claim 1, comprising an alkanol alkoxylate of the formula (I),
R—O—(—AO)mR′ (I)
in which
R is a straight-chain or branched alkyl having 4 to 20 carbon atoms,
R′ is H, methyl, ethyl, n-propyl, isopropyl, n-butyl, isobutyl, tert-butyl, n-pentyl or n-hexyl,
AO is an ethylene oxide radical, a propylene oxide radical, a butylene oxide radical or for mixtures of ethylene oxide and propylene oxide radicals or butylene oxide radicals and
m is an integer from 2 to 30.

4. A method of controlling animal pests, comprising delivering an effective amount of at least one active agrochemical compound in a neat or dilute composition according to claim 1 to plants, their habitat, their seed, pests, or a combination thereof.

5. (canceled)

6. A non-aqueous composition according to claim 1, comprising
at least one active agroehemical compound from the group of the pyrethroid,
at least one surfactant of the formula (I)
R—O—(—AO)mR′ (I)
in which
R is a straight-chain or branched alkyl having 4 to 20 carbon atoms,
R′ is H, methyl, ethyl, n-propyl, isopropyl, n-butyl, isobutyl, tert-butyl, n-pentyl or n-hexyl,
AO is an ethylene oxide radical, a propylene oxide radical, a butylene oxide radical or a mixture of ethylene oxide and propylene oxide radicals or butylene oxide radicals and
m is an integer from 2 to 30,
at least one water-immiscible solvent,
at least one anionic emulsifier,
at least one polar co-solvent selected from the group consisting of dimethyl sulphoxide, N alkylpyrrolidone, gamma-butyrolactone, ethylhexyl palmitate, 2-ethylhexyl S lactate, cyclohexanone and dimethylpropyleneurea.

7. A composition according to claim 6, comprising beta-cyfluthrin, deltamethrin or a combination thereof.

8. A composition according to claim 6, wherein the anionic emulsifier is an alkali metal salt or alkaline earth metal salt of an alkylsulfonic acid or alkylarylsulfonic acid.

9. A method of controlling animal pests, comprising delivering an effective amount of at least one active agrochemical compound in a neat or dilute composition according to claim 6 to plants, their habitat, their seed, pests, or a combination thereof.

10. (canceled)

11. A composition according to claim 2, comprising an alkanol alkoxylate of the formula (I),
R—O—(—AO)mR′ (I)
in which
R is a straight-chain or branched alkyl having 4 to 20 carbon atoms,
R′ is a H, methyl, ethyl, n-propyl, isopropyl, n-butyl, isobutyl, tert-butyl, n-pentyl or n-hexyl,
AO is an ethylene oxide radical, a propylene oxide radical, a butylene oxide radical or a mixture of ethylene oxide and propylene oxide radicals or butylene oxide radicals and
m is an integer from 2 to 30.

12. A method of controlling animal pests, comprising delivering an effective amount of at least one active agrochemical compound in a neat or dilute composition according to claim 2 to plants, their habitat, their seed, pests, or a combination thereof.

13. A method of controlling animal pests, comprising delivering an effective amount of at least one active agrochemical compound in a neat or dilute composition according to claim 3 to plants, their habitat, their seed, pests, or a combination thereof.

14. A composition according to claim 7, wherein the anionic emulsifier is an alkali metal salt or alkaline earth metal salt of an alkylsulfonic acid or alkylarylsulfonic acid.

15. A method of controlling animal pests, comprising delivering an effective amount of at least one active agrochemical compound in a neat or dilute composition according to claim 7 to plants, their habitat, their seed, pests, or a combination thereof.

16. A method of controlling animal pests, comprising delivering an effective amount of at least one active agrochemical compound in a neat or dilute composition according to claim 8 to plants, their habitat, their seed, pests, or a combination thereof.
